(19) United States
(12) Patent Application Publication
(10) Pub. No.: US 2010/0110698 A1
(43) Pub. Date: May 6, 2010

(54) Universal Housing for Recessed Lighting

(75) Inventors: Ronald P. Harwood, Farmington Hills, MI (US); Doug Highbridge, Hopewell Junction, NY (US)

Correspondence Address: LAW OFFICES OF NATAN EPSTEIN, 11377 WEST OLYMPIC BOULEVARD, TRIDENT CENTER - 9TH FLOOR, LOS ANGELES, CA, 90064, US

(73) Assignee: USAI, LLC, New Windsor, NY (US)

(21) Appl. No.: 12/471,135

(22) Filed: May 22, 2009

Related U.S. Application Data
(60) Provisional application No. 61/055,963, filed on May 23, 2008.

(51) Int. Cl. F21V 15/00; F21V 19/02; F21V 21/00

(52) U.S. Cl. 362/365; 362/372; 362/371

(57) ABSTRACT

A light housing for recessed installation in a ceiling plenum has a top, an apertured bottom, and side walls between the top and bottom. Housing support brackets may be attached at three alternate locations on the side walls for hanging the housing between joists in a ceiling plenum, such that the housing can be hung in any of three different orientations to fit available space in the ceiling plenum. A lamp socket in the housing is tiltable about two different axes through a first angular adjustment between a downlight position and a wallwash position and tiltable through a second angular adjustment between a downlight position and an adjusted position, such that a directional light source installed in the lamp socket may be aimed for downlight, wallwash or adjustable illumination after installation of the housing in a ceiling.

This application claims priority to the filing date of provisional patent application 61/055,963 filed May 23, 2008

### BACKGROUND OF THE INVENTION

1. Field of the Invention

This invention relates generally to the field of interior and architectural lighting and more specifically concerns a recessed light housing for mounting between ceiling joists in a ceiling plenum.

2. State of the Prior Art

Recessed lighting is installed in hollow ceiling spaces such that the lighting fixture is hidden above an interior ceiling with only an opening and surrounding trim visible from below the ceiling. Recessed lighting is widely used for residential and commercial applications.

Recessed light fixtures fall into three broad categories: down lights, which direct the light output straight down from the ceiling; wall wash lights, which throw oblique illumination from the ceiling onto a nearby wall surface; and adjustable lights in which a directional light source can be selectively aimed towards an area or object not directly underlying the fixture, such as an artwork on display or a furniture grouping.

The recessed light typically includes a housing of sheet metal supported above an opening in the interior ceiling. The recessed housing is connected to a source of electrical power with electrical conduit or the like pursuant to applicable building codes and regulations. The recessed housing encloses the light source or lamp, often a high intensity lamp, and prevents contact of the hot light source with flammable material in the ceiling space. The bottom of the recessed enclosure has an aperture which is aligned with an opening cut in the interior ceiling. The opening is normally finished with an ornamental trim which may also serve to support various accessories such as lenses, light diffusers, condensers, baffles, filters and the like, either in or under the aperture of the recessed housing.

A common method of supporting recessed light housings is by hanging from existing ceiling joists such as wooden beams. A pair of parallel hanger bars is nailed to the joists and the recessed housing is hung between the two hanger bars by means of hanger brackets fastened to the recessed housing. One type of hanger bracket in common use is known as a butterfly bracket. These have a center portion that is fixed to the recessed housing and two wings spreading from the center portion and perforated to pass the hanger bars in a sliding fit through the two wings. Two such hanger brackets are normally attached on opposite sides of the housing with a hanger bar sliding through both wings of each bracket, such that the housing hangs between the two hanger bars. The hanger brackets are normally repositionable along a vertical line on the recessed housing so that the housing can be raised or lowered relative to the hanger bars, for adjusting the height of the recessed housing relative to the ceiling.

Recessed light housings are available in a variety of shapes, some of them cylindrical cans, others shaped as square or rectangular boxes. Some of the housings typically have an exterior junction box fixed to one side of the housing which houses the connection between the electrical conduit supplying power to the fixture and the fixture's internal wires leading to the lamp socket in the housing. Depending on the light source used in a particular fixture, a transformer or ballast box is also attached to the exterior of the recessed housing.

Ceiling spaces are increasingly crowded with ventilation ducts, fire sprinkler systems, conduits of various kinds for data cables, audio wiring, surveillance systems and layers of insulation, among still other artifacts. It often happens that a fixture cannot be installed in an optimal location because of such impediments in the ceiling space. For example, the exterior junction box and possibly a transformer or ballast on the housing may interfere with other objects and force displacement of the fixture to a less desirable location. Even the shape of the fixture housing may keep it from fitting between other structures in an available space, yet the fixture housing cannot be turned, for example, because the hanger brackets and hanger bars force a given orientation of the housing relative to the ceiling joists.

This is particularly the case with conventional square recessed housings of the type having four side walls of approximately equal length. At least one of the walls carries a junction box, and the opposite wall may carry a ballast or transformer, leaving only the other two walls available for attaching the housing hanger brackets. Consequently, such a housing can be hung in only one position between two ceiling joists, that is, with the two available sides facing towards and parallel to the joists. The conventional housing cannot be reoriented so as to conform to and fit within differently shaped spaces between existing obstacles in the ceiling space. Instead, it is necessary to move the recessed housing to a location where the fixed orientation of the housing can be accommodated by the existing topography of the ceiling space.

Another difficulty found in prior art recessed lights is the need to anticipate and specify the type of recessed lights required at each location of a multi-fixture installation. This is because recessed fixtures are usually sold for a particular purpose: downlights, wallwash lights or adjustable lights, and an installer must purchase and install the particular kind of fixture at each location. Yet it is difficult to anticipate which of these three types of illumination will give best effect until the fixtures are in place and the lighting effects can be observed. If, after installation it is decided that a different type of recessed fixture would be preferable, say an adjustable fixture instead of a wallwash, it may be necessary to replace the light fixture or some substantial part of it. In a new building with possibly hundreds of recessed light fixtures such replacements can add substantially to overall costs.

What is needed is recessed light fixtures with a more flexible installed footprint in the ceiling space and convenient reconfiguration of the installed fixture between downlight, wallwash and adjustable light functions.

### SUMMARY OF THE INVENTION

This invention addresses these and other shortcomings of the prior art by providing a light housing for recessed installation in a ceiling plenum, the housing having a top, an apertured bottom and a number of side walls between the housing top and the housing bottom, and at least three pairs of bracket attachment sites for fastening hanger brackets to the housing. The mounting brackets may be butterfly brackets of a type currently used for hanging recessed light fixtures from hanger bars.

Each of the three pairs of attachment sites is located on a corresponding pair of mutually opposed side walls. Any one of the three pairs of attachment sites accepts installation of two hanger brackets for hanging the housing from two hanger bars, such that the housing can be hung in any one of three different orientations in a ceiling plenum.

The three pairs of bracket mounting sites are respectively located on first, second and third pairs of mutually opposed side walls, with the first and second mutually opposed wall pairs being mutually perpendicular and the third mutually opposed wall pair being diagonal to the first and second wall pairs.

In one form of the invention the housing has four mutually opposed side wall pairs in a generally octagonal side wall configuration. More particularly, four side walls are longer and four side walls are shorter, the shorter walls alternating with the longer walls so that the housing in horizontal cross section is a square with truncated corners. That is, the housing may have four major walls arranged in a cross sectional square configuration and four minor walls truncating the square configuration. Bracket mounting sites are preferably provided on all four of the minor walls and on two of the major walls.

Each bracket mounting site may include a bracket mounting opening such as a vertical slot in a side wall. A retainer plate interior to the housing is fastened through the bracket mounting opening to a mounting bracket exterior to the housing, capturing the side wall between the plate and the bracket in an interference fit and thereby securing the mounting bracket to the housing. For example, the retainer plate and the mounting bracket may be fastened to each other with threaded fasteners extending through the mounting opening and tightened with nuts on the threaded fasteners. A vertically elongated mounting opening such as a vertical slot allows the retainer plate and mounting bracket to be located at a selected height along the slot so that the vertical position of the housing can be adjusted up or down when hung from the hanger bars.

In a preferred form of the invention the housing has a top, an apertured bottom and eight side walls between the top and the bottom including four major walls arranged in two opposing pairs, and four minor walls each interposed between two of the major walls. The side walls are joined at an internal angle of approximately 135 degrees and define an eight sided polyhedron between the top and bottom of the housing. Bracket mounting sites are provided on each of the minor walls and on one pair of the major walls, each bracket mounting site adapted for receiving a hanger bracket for use in hanging the housing from hanger bars between ceiling joists in the ceiling plenum. That is, six bracket mounting sites are provided on six side walls and a pair of butterfly brackets may be fastened to any two bracket mounting sites on an opposing pair of side walls, for a total of three possible locations of the two hanger brackets on the housing.

In another aspect of the invention a recessed light housing has a housing top, an apertured bottom, a plurality of side walls between the top and the bottom, hanger brackets for supporting the housing between joists in a ceiling plenum with the apertured bottom facing downwardly from the ceiling plenum, a yoke rotatable in the housing about a vertical axis of the housing, an adjustment bracket pivoted to the yoke for movement between a vertical downlight position and an inclined adjusted position, and a lamp socket tiltable on the adjustment bracket between a downlight position and a wallwash position, such that a directional light source installed in the lamp socket may be interchangeably oriented for downlight, wallwash or adjustable illumination after installation of the housing in a ceiling.

The pivotable adjustment bracket swings the lamp socket in one direction through a first arc about a first axis between the downlight position and an adjusted position. The lamp socket is tiltable on the adjustment bracket along a second arc in an opposite direction to the adjustment arc about a second axis between the downlight position and the wallwash position, such that the wallwash tilted position is angularly subtracted from the adjusted position. The first and second axes are mutually parallel. In the presently preferred arrangement the first arc faces downwardly towards the apertured housing bottom and the second arc faces upwardly towards the housing top.

Preferably, the yoke is rotatable through substantially 360 degrees about a vertical axis, the adjustment bracket can swing through a first tilt angle of about 40 degrees from the downlight position to a maximum adjusted position, and the lamp socket is tiltable through a second tilt angle of about 12 degrees relative to the swing bracket between its downlight position on the adjustment bracket and its wallwash position. The downlight position of the swing bracket is vertical in the housing and the downlight position of the lamp socket is vertical relative to the swing bracket.

The yoke may have an inverted U shape with a yoke center fastened for rotation to the housing top and a pair of yoke arms depending from the yoke center. The swing bracket has a pair of swing arms each pivoted about the first tilt axis to one of the yoke arms and a lamp socket carrier pivoted about the second tilt axis between the swing arms, the light socket being mounted on the socket carrier.

The tilt angle of the lamp socket to its wallwash position is small relative to the tilt angle of the swing bracket to a maximum adjusted position. Tilt stops are provided on the yoke for limiting tilting of the lamp socket about each tilt axis to facilitate precise positioning of the lamp socket in its wallwash position independently of tilting of the swing bracket.

An important aspect of the invention is the multiple axis adjustment of the directional light source in the housing. Placing the lamp in its wallwash bias position about one axis simultaneously with an inclined position of the adjustment bracket about another axis has the effect of bringing the lamp closer to the housing aperture than is the case if the adjustment bracket alone is tilted to a similar angle with no tilt about any other axis. The combined multi axis tilting results in a better cutoff of the projected light beam by the housing aperture with improved illumination performance.

### BRIEF DESCRIPTION OF THE DRAWINGS

FIG. 1 is a top side perspective view of the recessed light housing according to this invention;

FIG. 2 is a detail view showing how the butterfly hanger bracket is fastened to one side of the housing by means of an internal retainer plate and external nuts;

FIG. 3 is a cross-sectional of the installed butterfly hanger bracket showing how the housing sidewall is captured in an interference fit between the bracket and the internal retainer plate;

FIG. 4 is a bottom view of the light housing hung between two hanger bars which in turn extend between two joist beams in a ceiling space, the housing being installed with one pair of its minor side walls facing the joists and the hanger bars and the junction box on the right side;

FIG. 5 is a bottom view as in FIG. 4, with the hanger brackets mounted on the other pair of minor side walls so that the housing is turned 90 degrees counterclockwise relative to the orientation in FIG. 4 with junction box on the left side;

FIG. 6 is a bottom view showing the housing installed with its major sidewalls facing the hanger bars and the joists;

FIG. 7 is a bottom side view of the housing of FIG. 1 showing the hanger butterfly brackets installed on two mutually opposite minor side walls, and also illustrating how the brackets can be installed near the bottom of the housing;

FIG. 8 is a perspective view of the adjustable yoke shown above the housing bottom with the adjustment bracket and the socket carrier plate in their respective downlight positions;

FIG. 9 is a view as in FIG. 8 but showing the adjustment bracket in its fully adjusted, maximally inclined position and the socket carrier plate in its downlight position;

FIG. 10 is a view as in FIG. 9 but now showing the lamp socket carrier plate also tilted to its wallwash position relative to the adjustment bracket.

FIG. 11 is a vertical sectional view of the housing of FIG. 1 showing the adjustable yoke bracket suspended from the housing top and carrying a directional light source and further showing how the directional light source in the adjusted position of FIG. 7 can be further tilted relative to the adjustment bracket between a downlight position and a wallwash position independently of its adjusted position relative to the yoke;

FIG. 12 is a view as in FIG. 11 showing a single axis tilt of the light source to an angle similar to that of the combined two axis tilt of FIG. 11 to illustrate the resulting higher lamp position away from the housing aperture.

### DETAILED DESCRIPTION OF THE PREFERRED EMBODIMENTS

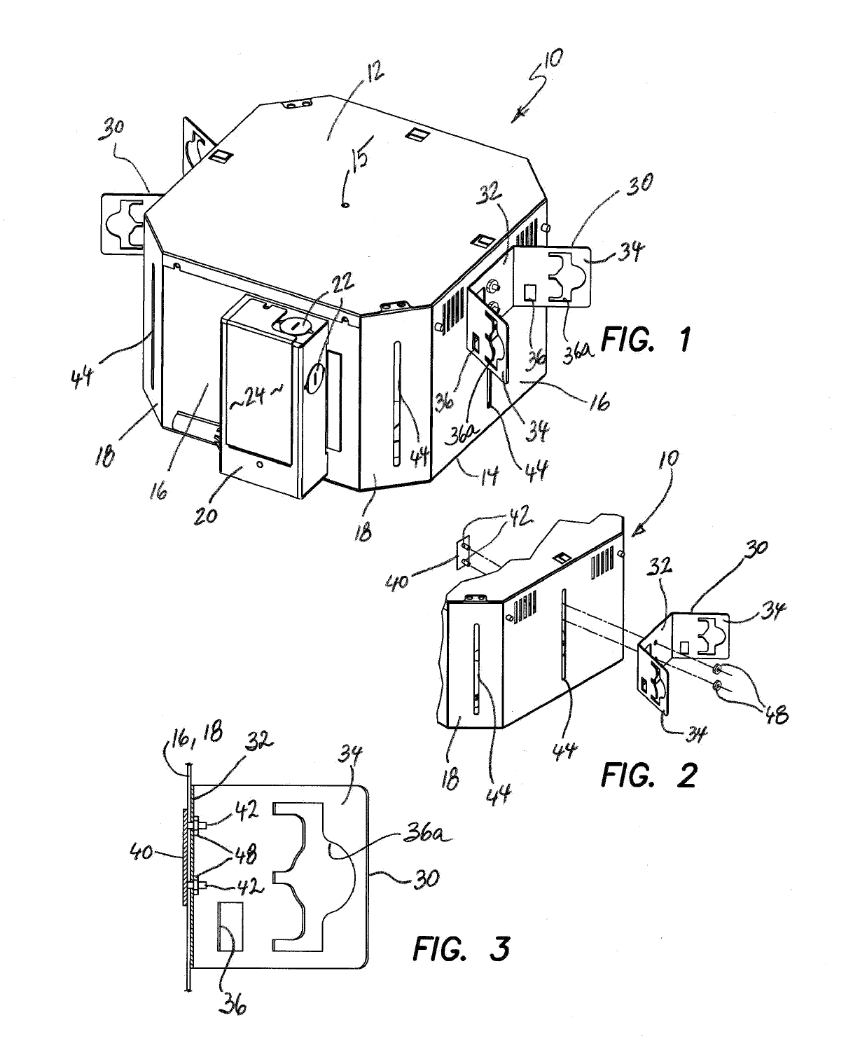

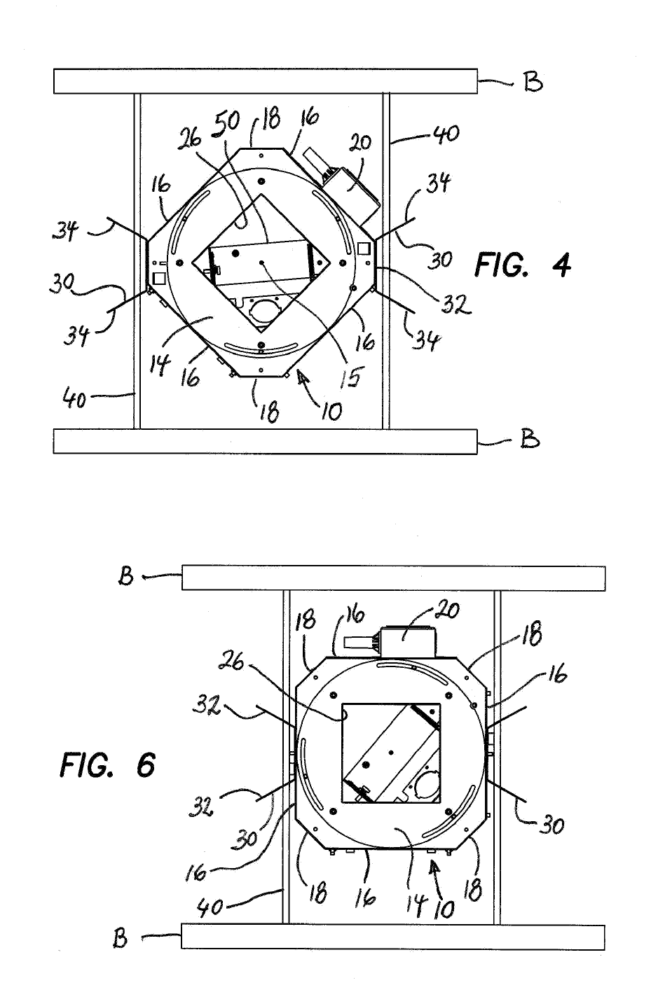

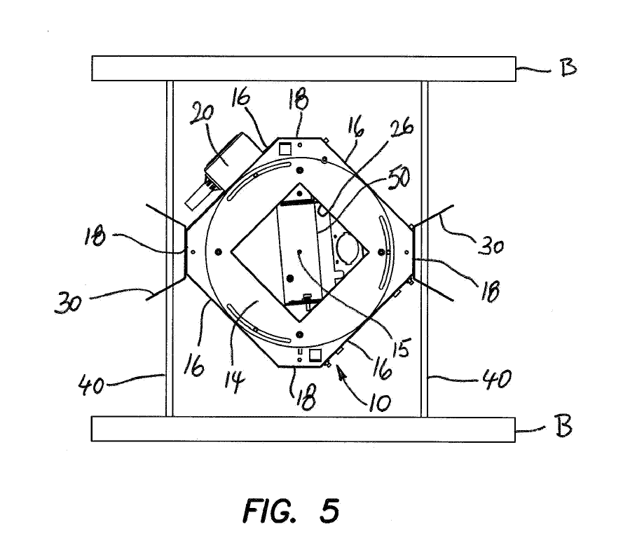

With reference to the accompanying drawings wherein like elements are designated by like numerals, FIG. 1 shows a recessed light housing generally designated by the numeral 10 which has a housing top 12, a housing bottom 14 and eight sidewalls which include four major sidewalls 16 and four minor sidewalls 18. The bottom 14 of housing 10 has an aperture 28 better seen in FIGS. 4 and 5. In the example of the drawings the aperture 28 is square but may take other shapes, such as circular or elliptical, for example. A junction box 20 is mounted on one major sidewall 16, and has knock-out openings 22 for admitting external electrical conduit to the junction box and connecting the fixture housing 10 to a source of electrical power. Electrical wires from the conduit reach into the junction box 20 where they are electrically connected to internal wiring of housing 10 which supplies electrical to a lamp socket for powering a lamp in the housing, all in a manner which is well known in the lighting trade and does not require detailed description here. A junction box cover 24 is removable to provide access into junction box 20 for making the electrical connection between the conduit wires and the housing's internal wiring. On some housings 10 a second exterior box (not shown) is mounted on the side wall 16 opposite the junction box 20 for housing a power transformer or a ballast, depending on the lamp used in the housing.

Light housing 10 is installed in a ceiling space or plenum by means of two hanger brackets 30 of a type known in the trade as butterfly brackets. Each butterfly bracket 30 has a flat bracket center 32 between two bracket wings 34 which spread away from opposite ends of the bracket center. Butterfly hanger brackets 30 are commonly used for hanging recessed light fixtures and do not require detailed explanation here. Briefly, the bracket 30 has an opening 36 on each wing 34 shaped to pass a hanger bar through the two openings 36, as seen in FIGS. 4 and 5. Two hanger bars 40, each passing through a corresponding hanger bracket 30 mounted on opposite sides of housing 10 are used to hang the housing 10 between a pair of ceiling joists or beams B. The ends of each hanger bar 40 are nailed or otherwise fastened to the beams B and the fixture housing 10 is suspended between the hanger bars. The butterfly bracket 30 also has a specially shaped opening 35a which can pass either certain c-channel bars or ½″ electrical conduit, both of which are used in the trade as alternatives to hanger bars 40 for suspending recessed light housings.

FIGS. 2 and 3 illustrate how a butterfly hanger bracket 30 is fastened to a sidewall 16, 18 of housing 10. An internal retainer plate 40 has two threaded fasteners 42 which pass through a bracket-mounting aperture in the form of vertical slot 44. The retainer plate 40 is applied against the interior surface of a sidewall 16, 18 with fasteners 42 passing through slot 44 to the exterior of the housing 10. The protruding ends of fasteners 42 pass through aligned holes 46 in the center 32 of the butterfly bracket 30 and a pair of nuts 48 are threaded onto the protruding fastener ends and tightened against the bracket center 32, thereby capturing the sidewall 16, 18 in an interference fit between the retainer plate 40 and the bracket 30, as best seen in the cross-section of FIG. 3. The retainer plate 40 and bracket 30 can be slid up and down along slot 44 before the nuts 48 are tightened on fasteners 42, for positioning the hanger bracket at a desired height on the side 16, 18 between the housing top 12 and housing bottom 14. This height adjustment of the two hanger brackets 30 on each side of the housing allows the housing 10 to be raised and lowered relative to the hanger bars 40 so as to bring the bottom or faceplate 14 of the housing down against the ceiling which normally underlies the recessed housing 10.

As best seen in FIGS. 4 and 5, the eight sidewalls 16, 18 form a generally eight sided polyhedron when seen in three dimensions and form a generally octagonal perimeter when seen in transverse horizontal cross section of housing 10. The preferred horizontal cross-sectional shape of the housing 10 is that of a square with truncated corners, with two pairs of mutually opposing major sidewalls 16 alternating with two pairs of mutually opposed minor sidewalls 18. The eight side walls include four longer major sidewalls 16 alternating with four shorter minor sidewalls 18. In the example of the drawings mutually adjacent side walls 16, 18 are joined to each other at a 135 degree internal angle.

One pair of major sidewalls 16 cannot receive hanger brackets 30 because of the presence of junction box 20 on one sidewall 16, which leaves the other pair of major sidewalls 16 available for mounting a pair of hanger brackets 30, providing one mounting configuration for two hanger brackets 30. All four of the minor sidewalls 18 are available for mounting of hanger brackets 30 and provide two additional mounting configurations for a pair of brackets 30. In total, three alternate hanger bracket mounting configurations are available on housing 10. Each vertical slot 44 serves as a hanger mounting opening and provides a mounting site or location for a hanger bracket 30. In total six hanger bracket mounting sites are provided on six sidewalls of housing 10. It should be understood that the hanger mounting openings are not limited to slots and differently shaped openings could be used.

In FIG. 4, brackets 30 are mounted on a first pair of minor sidewalls 18 resulting in a right side position of junction 20 in the Figure. In FIG. 5, the brackets 30 are mounted on the second pair of minor sidewalls 18, and housing 10 is turned 90 degrees from its orientation in FIG. 4 so that junction box 20 now lies on the left side of the housing near the left hanger bar 40. Such repositioning of the housing 10 is helpful for fitting the housing into cramped ceiling spaces, for example, if some existing obstacle prevents installation of the housing with the junction box oriented as in FIG. 4, the orientation of FIG. 5 may allow installation of the light fixture at a desirable location on the ceiling which otherwise would not be possible.

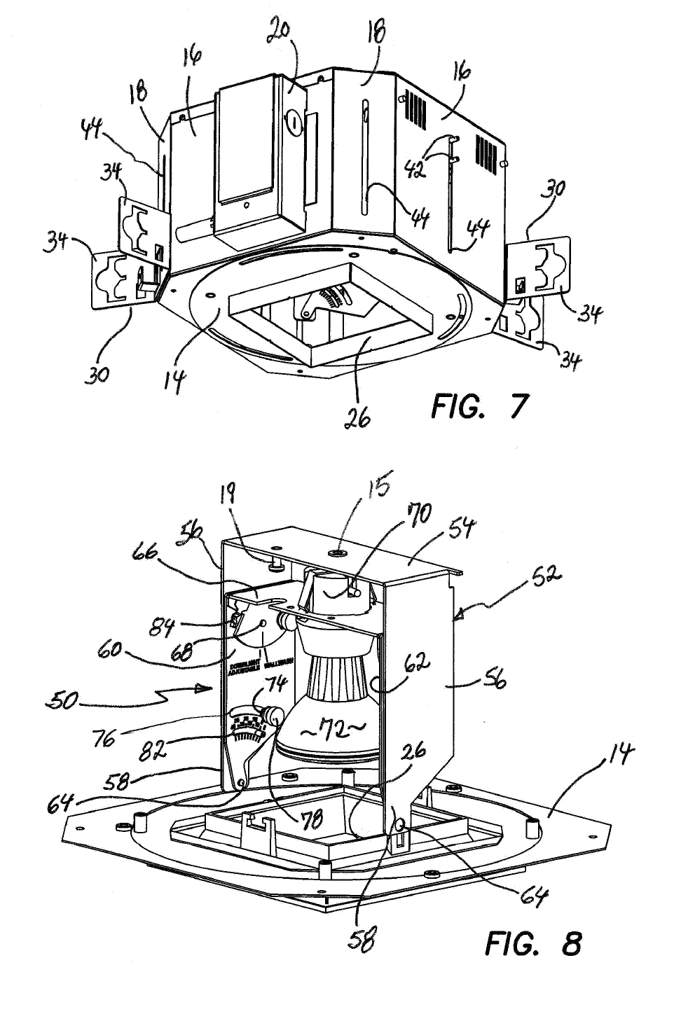

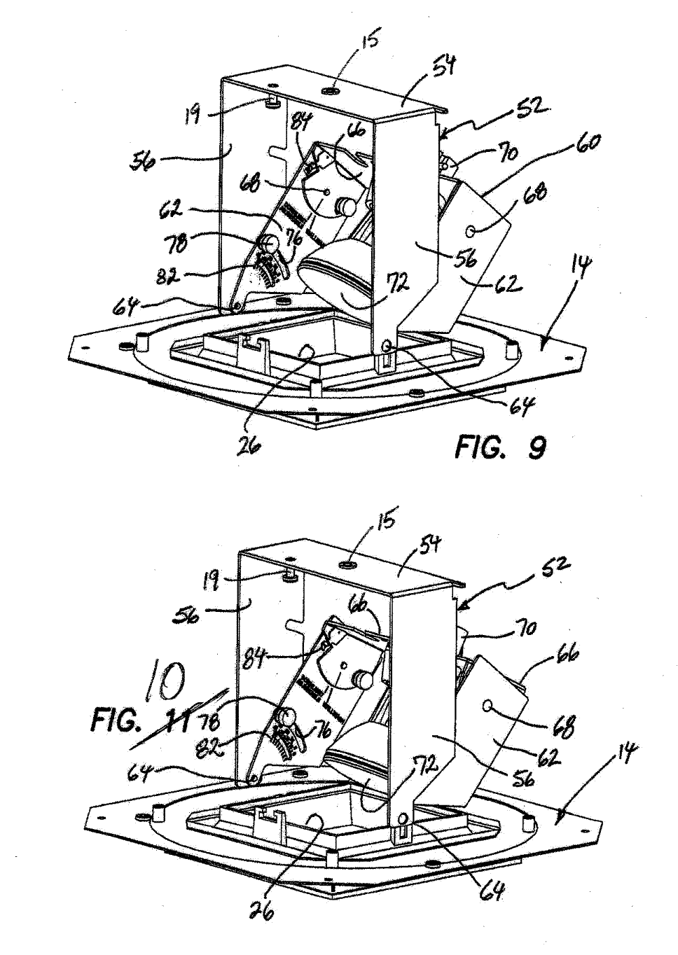

FIG. 6 illustrates a third orientation of the installed housing 10 where the hanger brackets 30 are mounted on the two available major sidewalls 16. In this orientation the junction box 20 lies about midway between the hanger bars 40 and near one joist beam B and housing 10 is turned midway between the orientations of FIGS. 4 and 5. In the three alternative orientations of FIGS. 4, 6 and 5 housing 10 is turned in 45 degree increments to present distinct footprints of the installed housing.

It will be noted that the width occupied by the housing 10 between the hanger bars 40 is smaller in the orientation of FIG. 6 and larger in the orientation of FIGS. 4 and 5. In FIGS. 4 and 5 the distance between the hanger bars 40 is greater because the diagonal dimension of the housing between the opposite minor sidewalls 18 is greater than the housing width between the pair of opposite major sidewalls 16. On the other hand, the housing 10 presents a different footprint in FIGS. 4 and 5 than in FIG. 6 and is able to fit between existing obstacles in a way which it could not if installed in the orientation of FIG. 6.

From the foregoing it is seen that three different orientations of the housing 10 are possible and available by mounting the pair of hanger brackets 30 on one of the three available mutually opposing pairs of sidewalls 16, 18, including one opposing pair of major sidewalls 16 and two opposing pairs of minor sidewalls 18.

FIG. 7 shows in perspective view the two hanger brackets 30 mounted on a pair of mutually opposing minor sidewalls 18, with brackets 30 positioned low on the housing 10 near the faceplate or bottom 14, in contrast to the higher mounting of brackets 30 near the housing top 12 in FIG. 1.

The invention is useful with housing shapes other than square housings having major side walls of equal horizontal length. Rectangular but not square housings where one pair of side walls is longer than a second transverse pair of side walls, and one of these side wall pairs is unavailable for mounting purposes because of external structures such as junction, transformer or ballast boxes on one or more side walls can be provided with alternate mounting attachment sites, for example on minor side walls provided on truncated corners between the major side walls according to this invention, to offer three or more alternate installed orientations of the housing in a given ceiling space. Generally, this invention provides alternate mounting positions where the housing is turned less than 90 degrees and preferably about 45 degrees between successive mounting positions, so as to offer a choice of distinct footprints for each of the alternate positions of the installed fixture.

The butterfly brackets 30 can be attached to the housing by means other than internal retainer plates 40. For example, the threaded studs 42 can be mounted on the brackets rather than on the plates, and inserted through slots 44 into corresponding holes on modified retainer plates, and nuts threaded on the stud ends inside housing 10. Another alternative is to fix threaded studs on the housing side walls and provide slots on the brackets 30. Yet another possibility is to eliminate brackets altogether and pass the hanger bars through openings provided in the housing 10 with no vertical adjustment of the housing height in the ceiling.

Brackets other than butterfly brackets may be used, or brackets replaced by other methods of supporting the recessed housing between ceiling joists or beams, so long as alternate sites are provided on the housing for attaching the supports to the housing and thereby provide multiple orientations of the installed housing relative to existing ceiling structure such that the footprint of a particular housing can be fitted to available space in a given ceiling. Turning now to FIGS. 8, 9 and 11, the recessed light fixture housing 10 contains an adjustable yoke assembly generally designated by numeral 50 which serves to support and adjustably aim a directional light source projecting a light beam through aperture 26 of the housing. The adjustable yoke assembly 50 includes a yoke 52 shaped as an inverted U with two yoke arms 56 depending from a yoke center 54 and terminating in lower ends 58 of the yoke arms. The yoke center is pivoted at 15, as by a rivet or screw and nut, to the housing top 12 for full circle, 360 degree rotation about a vertical axis in housing 10. A set screw 19 is provided to fix the yoke 50 against rotation in the housing 10.

A beam adjustment bracket 60 is supported between the yoke arms 56 and includes two swing arms 62 each with a lower end pivoted at 64 to a lower end 58 of a corresponding yoke arm 56. The upper ends of the swing arms 62 are interconnected by a lamp socket carrier plate 66 which is pivoted at 68 to the upper ends of each swing arm 62. An electrical lamp socket 70 is supported on the carrier plate 66 and is connected by electrical wiring (not shown) to the junction box 20, where the wires are connected to a source of electrical power as previously explained in connection with FIG. 1. Lamp socket 70 may hold any one of a variety of commercially available directional lamps 72 such as MR16, MR16MH, PAR 20 MH, among many others. Lamp 72 may be selected for its beam width, intensity, color spectrum and power requirement, depending on the desired lighting effect to be achieved with a particular light fixture installation. Typically the lamp 72 is a high intensity halogen or metal halide lamp provided with an internal parabolic light reflector which produces a directional beam of light. Commercially available lamps are available with narrow beams for spot lighting effect and wider beams for general illumination.

From the foregoing description and FIGS. 8, 9 and 11 it is seen that the lamp socket 70 and a light source 72 installed in socket 70 is angularly adjustable relative to yoke 52 about two mutually parallel and vertically spaced apart pivot axes. The lower adjustment axis passes through pivot points 64 of the swings arms 62, and the upper pivot axis passes through pivot points 68 of the lamp carrier plate 66. The lamp socket 70 and light source 72 are angularly adjustable or tiltable about each of these tilt axes independently of the other tilt axis.

The inclination or tilt adjustment of the swing arms 62 is limited by a stop screw 74 fixed on one yoke arm 56 and passing through an arcuate slot 76 cut in the adjacent swing arm 62. A set knob 78 on stop screw 74 can be tightened against the swing arm 62 to fix the swing arm at a particular tilt or inclination relative to the yoke 52. An angle scale 82 is provided to facilitate aiming of the light source 72 at a particular adjusted angle relative to the vertical or downlight position. Tilting of the adjustment bracket 60 is limited to a preset adjustment arc by the opposite ends of the arcuate slot 76, which serve as tilt stops for the bracket 60.

A tilt stop 84 fixed to swing arm 62 limits titling of lamp carrier plate 66 about pivot points 68 and consequently limits tilting of the lamp socket 70 between a vertical or downlight position and a wallwash biased position relative to swing arms 62. The tilt arc of movement between the vertical downlight and titled wallwash positions of the lamp socket is limited by the stop 84 to twelve degrees. A twelve degree tilt has been found through experience to produce a good wallwash illumination effect in which the directional light source 72 grazes a wall surface located to one side of a ceiling mounted recessed light fixture 10. However, the optimum wallwash angle may vary depending on the particular light source 72 and whether any lens or other accessory is installed below the housing aperture 26 to modify the projected light beam of the fixture, and this invention is not limited to a particular wallwash angle.

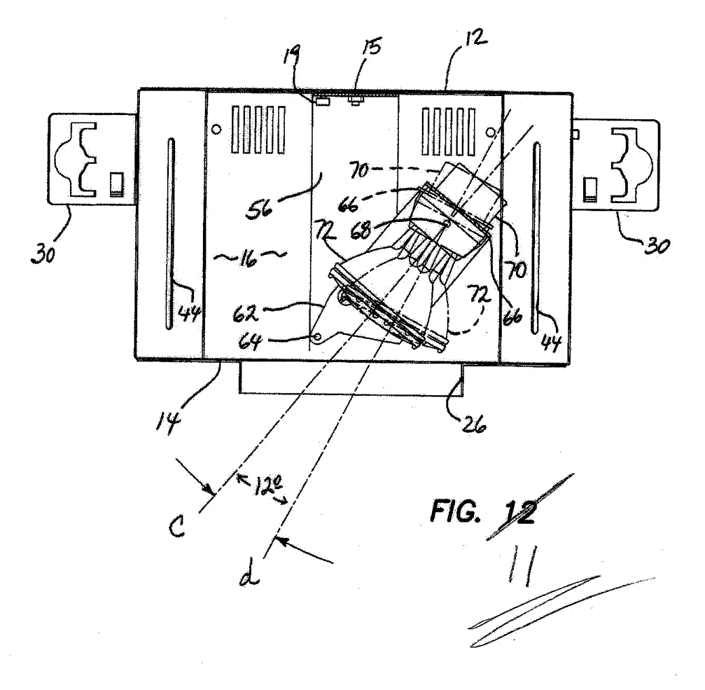

The adjustment arc of the swing arm 62 is larger and is preferably set to a maximum arc of 40 degrees. The adjustment bracket 60 is continuously adjustable between the zero-degree vertical downlight position of FIG. 8 and the fully inclined forty-degree adjusted position of FIG. 9. Tilting of the adjustment bracket 60 swings the light beam produced by lamp 72 across an arc of about forty degrees. Coupled with 360 degree rotation of the yoke 52 relative to the housing top 12 a directional lamp 72 can be aimed or adjusted over a wide area under the recessed light fixture, and its light beam can be projected in any direction around the fixture and up to substantial elevation to illuminate a particular space or area. A directional light source which can be aimed in this fashion is known as an adjustable light in the recessed lighting trade.

FIG. 8 shows the adjustment bracket 60 and lamp socket carrier plate 66 both placed in their respective downlight positions, i.e. a zero-degree angle for the swing arms 62 and horizontal position for the carrier plate 66, directional lamp 72 points vertically and straight down through aperture 26, a position known in the recessed lighting trade as a downlight. This configuration is used for downlight installations of housing 10.

FIG. 9 shows the adjustment bracket 60 adjusted to a fully inclined position, tilted at a 40 degree angle relative to the yoke 50, but the lamp socket carrier plate 66 still in its zero degree, vertical downlight position relative to the swing arms 62. As was previously explained, the adjustment bracket can be tilted to any angle between the downlight position of FIG. 8 and the maximally inclined position of FIG. 9. This configuration is used for adjustable light installations of housing 10.

The light beam axes corresponding to the positions of lamp 72 of FIG. 8 and FIG. 9 describe a forty degree arc between the downlight position of FIG. 8 and the fully inclined position of FIG. 9 as a result of adjustment of the bracket 60 about pivot 64, that is, the lower adjustment axis of the yoke assembly 50.

FIG. 10 shows the lamp socket carrier plate 66 tilted to its 12 degree wallwash position relative to swing arms 62, in addition to and independently of the inclination of the adjustment bracket 60. This results in a net light beam angle of 28 degrees to the vertical because the wallwash bias angle of 12 degrees is subtracted from the 40 degree inclination of the adjustment bracket 60.

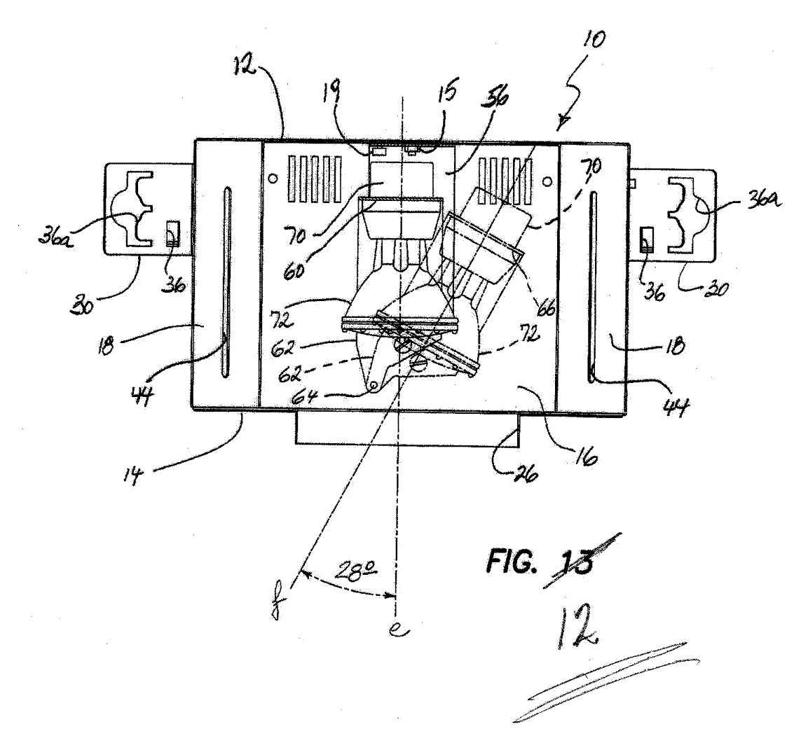

This condition of the lamp 72 is shown in the cross-sectional view of FIG. 11, where the adjustment bracket is tilted to its maximum forty-degree position and the lamp carrier plate is titled twelve degrees to its wallwash position. That is, the lamp socket 70 and lamp 72 are tilted about both the lower and upper tilt axes of the adjustment bracket 50. The two tilt arcs corresponding to these two tilt axes face away from each other. The swing arc corresponding to the lower axes faces downwardly while the swing arc corresponding to the upper axes faces upwardly in the housing 10. As a result, the inclination away from the vertical of the light beam axes is reduced by the combined two axes tilt. Tilting the adjustment bracket on its maximum forty-degree inclination places the beam axis at a forty-degree angle to the vertical. Then, tilting the lamp to its wallwashed biased position of twelve degrees relative to the adjustment bracket subtracts the twelve degree bias from the forty degree initial adjustment, resulting in a beam axis angle of twenty-eight degrees to the vertical, as in FIG. 11.

Each of the two axes of angular adjustment described above may be replaced by two or more adjustment axes which in combination achieve an adjustment of the light source equivalent to that of the two axes.

The configuration where swing arms 62 which are set to their vertical downlight position, as in FIG. 8 and the lamp socket carrier plate is set to its tilted wallwash position as in FIG. 9 results in a beam angle of 12 degrees to the vertical for grazing and washing light over a vertical wall surface adjacent to the recessed ceiling fixture 10. Such a configuration is used for wallwash installations of housing 10.

Placing the lamp 72 in its wallwash bias position simultaneously with an inclined position of the adjustment bracket as in FIG. 11 has the effect of bringing the lamp 72 closer to the housing bottom or faceplate 14 and to the aperture 26 than would be the case if the adjustment bracket 60 alone were tilted to a twenty-eight degree inclination while the lamp carrier plate 66 remained in its zero-degree downlight vertical position. The latter condition is shown in FIG. 12 where the angle of the inclined beam axis f is also near twenty-eight degrees to the vertical downlight position e, but the tilted lamp 72 is positioned somewhat higher up in the housing and further away from the housing aperture 26 than in FIG. 11. The combined tilting of the adjustment bracket and socket carrier plate 66 of FIG. 11 places the lamp 72 closer to the aperture 26 and results in a better cutoff of the projected light beam. It has been found in practice that in this combined tilt configuration the light beam when projected as a wallwash onto an adjacent vertical wall surface the light reaches higher up on the wall surface because of the closer positioning of the lamp to the aperture 26 in FIG. 11. This is believed to happen because the edges of aperture 26 cut-off less of the beam when lamp 72 is closer to the aperture, thus allowing more of the light beam to reach the wall surface, particularly a higher part of the wall which would not be illuminated in the lamp configuration of FIG. 12.

The two aspects of the invention described above, namely, the housing 10 repositionable to three alternate mounting positions between a pair of ceiling joists, and the dual axis adjustable yoke assembly 50 are complementary aspects of the invention. Adjustability of the light beam through rotation and tilting of the yoke assembly 50 cooperate to allow reorientation of the housing 10 in a ceiling space, so that regardless of the installed orientation of the housing, the beam of light source 72 can be configured for the desired lighting effect, whether downlight, wallwash or adjustable light.

A particular embodiment of the invention has been shown and illustrated for purposes of clarity and example only, and it must be understood that various changes, substitutions and modifications to the described embodiment will be apparent to those skilled in the art without thereby departing from the invention as defined by the following claims.

What is claimed is:

1. A light housing for recessed installation in a ceiling plenum, comprising:
a housing having a housing top, an apertured housing bottom and a plurality of side walls between said top and said bottom, and at least three pairs of bracket attachment sites for fastening hanger brackets to said housing brackets, any one of said three pairs of bracket attachment sites accepting installation of two housing support brackets for hanging the housing from hanger bars supported between ceiling joists in a ceiling plenum such that said housing can be hung in any of three different orientations between the ceiling joists in the ceiling plenum.

2. The housing of claim 1 wherein said three pairs of bracket mounting sites are respectively located on first, second and third pairs of mutually opposed side walls, the side walls of said first and second pairs being mutually perpendicular, the side walls of said third pair being diagonal to said mutually perpendicular side walls.

3. The housing of claim 1 wherein said housing has four of said mutually opposed pair of said side walls in a generally octagonal side wall configuration.

4. The housing of claim 1 wherein each of said bracket mounting sites comprises a vertical slot in one said side walls.

5. The housing of claim 1 wherein each of said bracket mounting sites comprises a hanger bracket mounting opening in one of said side walls through which a retainer plate interior to said housing is fastened to a hanger bracket exterior to said housing thereby to secure the hanger bracket to the housing.

6. The housing of claim 5 wherein said retainer plate is fastened to said hanger bracket with one or more threaded fasteners extending through said mounting opening.

7. The housing of claim 5 wherein said mounting opening is a vertical slot in a corresponding one of said side walls such that a said hanger bracket may be positioned at a selected height along said slot thereby to adjust the vertical position of said housing when hung from said hanger bars.

8. The housing of claim 1 wherein said hanger brackets are butterfly brackets.

9. The housing of claim 1 wherein said housing has eight of said side walls configured in transverse cross section as a square with truncated corners.

10. The housing of claim 1 wherein said housing includes four major walls arranged in a cross sectional square configuration and four minor walls truncating said square configuration.

11. The housing of claim 10 wherein said bracket mounting sites are located on all four of said minor walls and on two of said major walls.

12. A light housing for recessed installation in a ceiling plenum, comprising:
a housing having a housing top, an apertured housing bottom and eight side walls between said top and said bottom including four major side walls arranged in two opposing pairs, and four minor side walls each interposed between two of said major side walls, and bracket mounting sites on each of said minor side walls and on one pair of said major side walls, each bracket mounting site adapted for mounting a housing hanger bracket for use in hanging said housing from hanger bars between ceiling joists in the ceiling plenum.

13. The light housing of claim 12 wherein mutually adjacent ones of said side walls are joined to each other at an internal angle of approximately 135 degrees.

14. The light housing of claim 12 wherein said side walls generally define an eight sided polyhedron between said top and said bottom.

15. The light housing of claim 12 further comprising a pair of butterfly brackets fastened to two of said bracket mounting sites on any opposing pair of said side walls.

16. A light housing comprising a housing top, an apertured housing bottom, eight side walls between said top and said bottom, wherein said side walls are joined at an internal angle of 135 degrees, and hanger bracket mounting sites provided on at least six of said side walls for fastening housing hanger brackets to said light housing.

17. The light housing of claim 16 wherein said housing hanger brackets are butterfly brackets.

18. A light housing having a housing top, an apertured housing bottom, a plurality of side walls between said top and said bottom, hanger brackets for supporting said housing between joists in a ceiling plenum with said apertured bottom opening downwardly from said ceiling plenum,
a yoke in said housing rotatable about a vertical axis of the housing and a lamp socket on said yoke tiltable about a first tilt axis between a downlight position and a wallwash position, and tiltable about a second tilt axis between a downlight position and an adjusted position, said first and said second tilt axis being mutually parallel such that a directional light source installed in said lamp socket may be interchangeably aimed for downlight, wallwash or adjustable illumination after installation of the housing in a ceiling.

19. The light housing of claim 18 wherein said yoke is rotatable through substantially 360 degrees about said vertical axis.

20. The light housing of claim 18 wherein said lamp socket is tiltable through a first tilt angle of about 40 degrees between said downlight position and said adjusted position.

21. The light housing of claim 18 wherein said lamp socket is tiltable through a second tilt angle of about 12 degrees between said downlight position and said wallwash position.

22. The light housing of claim 18 wherein said yoke has a yoke center fastened for rotation to an interior surface of said housing top and a pair of yoke arms depending from said center, a tilting bracket assembly having a pair of swing arms each pivoted about said first tilt axis to one of said yoke arms and a socket carrier pivoted about said second tilt axis between said swing arms, said lamp socket being mounted on said socket carrier.

23. The light housing of claim 22 wherein said second tilt axis is vertically spaced from said first tilt axis in said housing and said lamp socket is tilted to said wallwash position and to said adjusted position in the same direction but along oppositely facing arcs.

24. The light housing of claim 18 further comprising tilt stops on said yoke for limiting tilting of said socket about each said tilt axis, and wherein said wallwash position is a small tilt angle relative to said adjusted angle, such that said tilt stops facilitate precise tilting of the lamp socket to said wallwash position about said second tilt axis independently of tilting to an adjusted position about said first tilt axis.

25. The light housing of claim 18 wherein;
said lamp socket is vertically aligned relative to said housing in said downlight position;
said wallwash position is tilted away from said downlight position along an upwardly facing arc; and
said adjusted position is tilted away from said downlight position along a downwardly facing arc.

26. The light housing of claim 18 wherein said further comprising a tilt stop for detaining said lamp socket carrier plate at said wallwash biased tilt and wherein a directional lamp installed in said lamp socket is positioned closer to said apertured housing bottom in a combined tilt to said adjusted position of said adjustment bracket and to said wallwash position of said lamp socket carrier plate than in an adjusted position of said adjustment bracket alone to a similar tilt as said combined tilt.

27. A light housing having a tilting bracket assembly pivoted in said housing for tilting between a vertical downlight position and an inclined adjusted position in a first direction along a downwardly facing swing arc and a lamp socket pivoted to said tilting bracket assembly for tilting between a vertical downlight position and a biased wallwash position also in said first direction along an upwardly facing arc.

28. The light housing of claim 27 wherein said downwardly facing arc and said upwardly facing arc are centered on corresponding mutually parallel first and second tilt axes in said housing.

29. The light housing of claim 27 wherein said wallwash position places a lamp installed in said socket closer to said apertured bottom when said tilting bracket assembly is tilted towards said adjusted position resulting in a better cutoff angle of a beam of light projected by a directional lamp installed in said socket.

30. A light housing having a housing top, an apertured bottom, a plurality of side walls between said top and said bottom, hanger brackets for supporting said housing between joists in a ceiling plenum with said apertured bottom opening downwardly from said ceiling plenum;
a yoke of inverted U-shape including a yoke center supported for rotation about a vertical axis of the housing and a pair of yoke arms depending from said yoke center;
a tilting bracket assembly of inverted U shape having two swing arms and a lamp socket supported between upper ends of said swing arms;
said swing arms having lower ends pivoted to corresponding lower ends of said yoke arms for swinging said lamp socket in a first direction between a vertical position and an inclined adjusted position of said swing arms;
said lamp socket being tiltable relative to said swing arms in said first direction between a down light position and a wallwash position.
such that a directional lamp installed in said lamp socket may be positioned in either downlight, wallwash and adjusted positions relative to said apertured bottom of the housing.

31. The light housing of claim 30 wherein said yoke is rotatable in said housing through substantially 360 degrees about said vertical axis.

32. The light housing of claim 31 wherein said lamp socket is tiltable through a first tilt angle of about 40 degrees between said downlight position and said adjusted position.

33. The light housing of 31 wherein said lamp socket is tiltable through a second tilt angle of about 12 degrees between said downlight position and said wallwash position.

34. A light housing having a housing top, an apertured housing bottom, a plurality of side walls between said top and said bottom, hanger brackets for supporting said housing between joists in a ceiling plenum with said apertured bottom opening downwardly from said ceiling plenum,
a lamp socket in said housing tiltable through a first angular adjustment between a downlight position and a wallwash position and continuously tiltable through a second angular adjustment between a downlight position and an adjusted position, such that a directional light source installed in said lamp socket may be interchangeably aimed for downlight, wallwash or adjustable illumination after installation of the housing in a ceiling, said first angular adjustment and said second angular adjustment being made about different pivot axes.

35. The light housing of claim 34 wherein a directional lamp installed in said lamp socket is positioned closer to said apertured housing bottom in a combined tilt to said adjusted position and to said wallwash position of said lamp than in an adjusted position alone to a tilt angle similar to said combined tilt.

36. A light housing having a housing top, an apertured housing bottom, a plurality of side walls between said top and said bottom, hanger brackets for supporting said housing between joists in a ceiling plenum with said apertured bottom opening downwardly from said ceiling plenum,
a yoke carrying a lamp socket in said housing, said yoke adjustable about more than one tilt axis for positioning said lamp socket in a combined adjusted and wallwash position wherein a directional lamp installed in said lamp socket is positioned closer to said apertured housing bottom than in an adjusted only position of said yoke having a tilt angle similar a tilt angle of said combined adjusted and wallwash position.

37. The light housing of claim 36 wherein said lamp socket is tiltable through a first angular adjustment between a downlight position and a wallwash position and continuously tiltable through a second angular adjustment between a downlight position and an adjusted position, wherein said first angular adjustment is independent of said second angular adjustment.

38. The light housing of claim 37 wherein said first angular adjustment is subtracted from said second angular adjustment in said combined adjusted and wallwash position.

39. A light housing for recessed installation in a ceiling plenum, comprising:
a housing having a housing top, an apertured housing bottom and a plurality of side walls between said top and said bottom, and at least three pairs of bracket attachment sites for fastening hanger brackets to said housing brackets, any one of said three pairs of bracket attachment sites accepting installation of two housing support brackets for hanging the housing from hanger bars supported between ceiling joists in a ceiling plenum such that said housing can be hung in any of three different orientations between the ceiling joists in the ceiling plenum; and
a lamp socket in said housing tiltable through a first angular adjustment between a downlight position and a wallwash position and continuously tiltable through a second angular adjustment between a downlight position and an adjusted position, such that a directional light source installed in said lamp socket may be interchangeably aimed for downlight, wallwash or adjustable illumination after installation of the housing in a ceiling, said first angular adjustment and said second angular adjustment being made about different pivot axes.
